(19) United States
(12) Patent Application Publication
(10) Pub. No.: US 2026/0162911 A1
(43) Pub. Date: Jun. 11, 2026

(54) COMPOSITE DEVICE FOR CAR ELECTRICAL PARTS AND MANUFACTURING METHOD THEREOF

(71) Applicant: SAMHWA CAPACITOR CO., LTD., Yongin-si (KR)

(72) Inventors: Young Joo OH, Yongin-si (KR); Jung Rag YOON, Yongin-si (KR); Jong Kyu LEE, Yongin-si (KR); Chang Ho LEE, Yongin-si (KR)

(21) Appl. No.: 19/179,717

(22) Filed: Apr. 15, 2025

(30) Foreign Application Priority Data
Aug. 28, 2024 (KR) 10-2024-0115822

(51) Int. Cl. H01G 17/00; H01C 1/08; H01C 7/112; H01C 17/065; H01G 4/12; H01G 4/258; H01G 4/33

(52) U.S. Cl. CPC H01G 17/00; H01C 1/08; H01C 7/112; H01C 17/065; H01G 4/1227; H01G 4/258; H01G 4/33

(57) ABSTRACT

Provided are a composite device for automotive electric parts and a manufacturing method thereof. The composite device includes: a multi-layered ceramic capacitor having a plurality of first and second internal electrodes alternately arranged; a multi-layered ceramic varistor having a plurality of third and fourth internal electrodes arranged to face each other, the multi-layered ceramic varistor being stacked on one side surface of the multi-layered ceramic capacitor; an adhesive layer made of an insulating heat dissipation ceramic adhesive for bonding the multi-layered ceramic capacitor and the multi-layered ceramic varistor; and first and second external electrodes which connect the plurality of first and second internal electrodes exposed to both end portions of the multi-layered ceramic capacitor with the plurality of third and fourth internal electrodes exposed to both end portions of the multi-layered ceramic varistor, respectively.

### TECHNICAL FIELD

The present disclosure relates to a composite device for automotive electric parts, and more particularly, to a composite device for automotive electric parts and a manufacturing method thereof, in which a multi-layered ceramic capacitor (MLCC) sintering chip and a multi-layered ceramic varistor (MLV) sintering chip on each of which an internal electrode is formed and an external electrode is not formed are bonded with each other by using a ceramic adhesive having excellent heat dissipation characteristics, and then a partial external electrode is formed only in a partial area where the internal electrodes of the MLCC and the MLV are connected to implement a parallel connection, thereby minimizing the transfer of heat generated from the MLV to the MLCC.

### BACKGROUND ART

MLCCs may serve as bypass, decoupling/coupling, charge storage, filtering, different frequency discrimination and circuit tuning in an electronic circuit.

MLVs are components of which resistances change according to a voltage change, and when a voltage is low, a resistance is high and thus a current does not flow, but a resistance sharply decreases above a specific voltage. When an overvoltage such as an electrostatic discharge (ESD) or a surge is applied to an MLV, the varistor resistance is rapidly reduced, and the overcurrent is bypassed to the ground, and thus, the MLV is used as a component for protecting an integrated circuit (IC) circuit.

Recently, in an electric vehicle (EV) power conversion system, the demand for high-capacity MLCCs is increasing in order to reduce noise and ripple current and to stabilize surge characteristics.

However, the demand for MLCCs increases, but the occurrence of surge due to switching in an electric vehicle battery system increases, and thus, due to the surge-based electrical energy in the MLCCs, an issue such as an insulation breakdown and a crack due to electric overstress (EOS) of the MLCCs may occur.

As described above, there is a need for a high-capacity MLCC in order to remove noise and stabilize a ripple current, but in the case of the MLCC, an EOS failure due to an overvoltage and an overcurrent may be caused by a high surge (i.e., an inrush current, a switching current, and an opening/closing current).

In particular, in an EV battery system, surge occurrence frequency due to a switching operation of a switching element provided in a direct-current/direct-current (DC/DC) inverter or a direct-current/alternating-current (DC/AC) inverter is large, and in order to solve this, a surge applied to the MLCC is absorbed by clamping a surge voltage using a device such as a varistor connected in parallel to the MLCC.

In general, a varistor has an ability to clamp a surge voltage, but has a low capacitance of 0.01 μF or less, and thus does not sufficiently remove noise or mitigate a ripple current/voltage.

As a result, in an EV battery system, when a high-capacity MLCC is used in preparation for a high rated voltage and a low-capacity varistor is coupled to a composite device, a low-capacity varistor does not sufficiently protect the MLCC. Accordingly, a crack or a short phenomenon may occur due to an influence of a surge in a high-capacity capacitor, and thus damage or a fire of the capacitor may occur.

That is, although the MLCC is capable of high capacity, mechanical destruction and electrical breakdown may occur due to a high surge, thereby causing fatal errors in a circuit.

In general, the MLCC is manufactured by adding MnO, rare earth metals (Y₂O₃, Dy₂O₃, or the like), and the like to the main composition of barium titanate (BaTiO₃) for high capacity, and the varistor is manufactured by adding Bi₂O3 or Pr₆O11 to a main composition of ZnO.

Although research has been conducted on a co-sintered composite device by simultaneously stacking an MLCC and a varistor, cracks may occur due to a difference in sintering shrinkage ratios between a barium titanate (BaTiO₃) material constituting the MLCC and ZnO constituting the varistor when co-sintered, and in the case of the varistor, it is difficult to sinter the varistor in a reducing atmosphere, so that expensive Ag—Pd, Pd, or Pt should be used as an internal electrode.

Recently, in the case of an MLCC, a Ni electrode is used to implement a cost-effectiveness and a high capacity, but expensive Ag—Pd, Pd, or Pt should be used as an internal electrode for matching with a varistor material.

In addition, in the related art, a product in which a varistor and an MLCC are adhered by a ceramic bonding material, an epoxy material, or the like is presented.

In the related art, a varistor and an MLCC are bonded to each other in a state in which an external electrode of each of the varistor and the MLCC is formed, and then the external electrode of each of the varistor and the MLCC is connected to provide a composite device connected in parallel, but heat may be transferred to the MLCC due to heat generation of the varistor for clamping a surge voltage when a surge is applied, which may generate a thermal shock or a mechanical impact may be applied to the MLCC due to a volume expansion, which may generate a crack.

### SUMMARY OF THE INVENTION

### Technical Problem

Therefore, it is an object of the present disclosure to solve the problems of the prior art, which provides a composite device for automotive electric parts and a manufacturing method thereof, in which a multi-layered ceramic capacitor (MLCC) sintering chip and a multi-layered ceramic varistor (MLV) sintering chip on each of which an internal electrode is formed and an external electrode is not formed are bonded with each other by using a ceramic adhesive having excellent heat dissipation characteristics, and then a partial external electrode is formed only in a partial area where the internal electrodes of the MLCC and the MLV are connected to implement a parallel connection, thereby minimizing the transfer of heat generated from the MLV to the MLCC.

It is another object of the present disclosure to provide a composite device for automotive electric parts and a manufacturing method thereof, which may prevent a crack from being generated between an external electrode and a ceramic body due to non-uniformity of heat transfer from an MLV sintering chip when an MLCC sintering chip and the MLV sintering chip are bonded using a ceramic adhesive.

It is another object of the present disclosure to provide a composite device for automotive electric parts and a manufacturing method thereof, in which an operation voltage of an MLV may be adjusted to a distance between internal electrodes according to a breakdown voltage (BDV) of an MLCC, and the MLCC and the MLV may be bonded by using a ceramic adhesive to prevent a thermal shock between the MLCC and the MLV.

### Technical Solution

According to an aspect of the present disclosure, there is provided a composite device for automotive electric parts, including: a multi-layered ceramic capacitor including a first dielectric layer having barium titanate (BaTiO₃) as a main ingredient and a plurality of first and second internal electrodes alternately arranged such that front end portions thereof cross each other with the first dielectric layer therebetween; a multi-layered ceramic varistor including a second dielectric layer having ZnO as a main ingredient, and a plurality of third and fourth internal electrodes arranged to face each other such that front end portions thereof are spaced apart from each other from both sides of the second dielectric layer, the multi-layered ceramic varistor being stacked on one side surface of the multi-layered ceramic capacitor; an adhesive layer arranged between the multi-layered ceramic capacitor and the multi-layered ceramic varistor and made of an insulating heat dissipation ceramic adhesive for bonding the multi-layered ceramic capacitor and the multi-layered ceramic varistor; and first and second external electrodes connecting the multi-layered ceramic capacitor and the multi-layered ceramic varistor in parallel by connecting the plurality of first and second internal electrodes exposed to both end portions of the multi-layered ceramic capacitor with the plurality of third and fourth internal electrodes exposed to both end portions of the multi-layered ceramic varistor, respectively, wherein the adhesive layer has a partial bonding structure in which a plurality of bonding portions to which the insulating heat dissipation ceramic adhesive is applied, and a plurality of gap forming portions for minimizing heat generated from the multi-layered ceramic varistor from being transferred to the multi-layered ceramic capacitor and absorbing the heat generated from the multi-layered ceramic varistor when volume expansion is performed due to a difference in thermal expansion coefficients between the multi-layered ceramic capacitor and the multi-layered ceramic varistor, are arranged between the plurality of bonding portions, and the plurality of bonding portions are formed in a range of 70% to 95% of the total bonding surface.

The plurality of bonding portions may be formed in any one of a linear shape, a circular shape, and a polygonal shape.

In addition, the insulating heat dissipation ceramic adhesive may include: a polymer matrix serving as a binder; and an insulating heat dissipation filler including a ceramic dispersed by adding 1 wt % to 10 wt % of the polymer matrix to improve thermal conductivity.

Further, the polymer matrix may include any one of epoxy-based, polyimide (PI)-based, urethane-based, acrylic-based, ester-based, and silicon-based polymers having a temperature stability of 250° C. to 500° C., and the insulating heat dissipation filler may include a ceramic having a thermal conductivity of about 3 W/mK or more, and an average particle diameter which may be set to about 0.1 μm to about 10 μm.

In addition, each of the first and second external electrodes may be formed at one side and the other side end portions of an assembly in which the multi-layered ceramic capacitor and the multi-layered ceramic varistor are assembled, the first external electrode may include a first electrode electrically connecting in parallel a first internal electrode of the multi-layered ceramic capacitor with a third internal electrode of the multi-layered ceramic varistor, and a first plating layer formed on an outer surface of the first electrode, the second external electrode may include a second electrode electrically connecting in parallel a second internal electrode of the multi-layered ceramic capacitor with a fourth internal electrode of the multi-layered ceramic varistor, and a second plating layer formed on an outer surface of the second electrode, and each of the first and second electrodes may form a partial electrode in a range in which heat generated from the multi-layered ceramic varistor does not affect the electrical connection with the first to fourth internal electrodes while minimizing the transfer of heat generated from the multi-layered ceramic varistor to the multi-layered ceramic capacitor through the first and second external electrodes.

In this case, the first electrode may include all layers of the first internal electrode of the multi-layered ceramic capacitor, cover 70% to 100% of the entire length of the first dielectric layer, include all layers of the third internal electrode of the multi-layered ceramic varistor, and cover 70% to 100% of the total length of the second dielectric layer, and the second electrode may include all layers of the second internal electrode of the multi-layered ceramic capacitor, cover 70% to 100% of the entire length of the first dielectric layer, include all layers of the fourth internal electrode of the multi-layered ceramic varistor, and cover 70% to 100% of the total length of the second dielectric layer.

In addition, the first and second electrodes may be partially formed on only a partial area of both sides required for electrical connection with the first to fourth internal electrodes, and widths (A1) of the first and second electrodes may be set to be in a range where 0.8×A2<A1<1.2×A2, and thicknesses of the first and second electrodes may be set to 0.1 μm to 5 μm, respectively.

Furthermore, the operating voltage of the multi-layered ceramic varistor may be determined by adjusting a distance between the third internal electrode and the fourth internal electrode of the multi-layered ceramic varistor in consideration of the breakdown voltage (BDV) of the multi-layered ceramic capacitor.

The adhesive layer may have a thickness of 1/50 to 1/100 of the multi-layered ceramic capacitor.

According to another embodiment of the present disclosure, there is provided a method of manufacturing a composite device for automotive electric parts, including: preparing a plurality of green sheets for multi-layered ceramic capacitors (MLCC) using a first dielectric material having barium titanate (BaTiO₃) as a main ingredient, forming first and second internal electrode layers on the surface of each of the plurality of MLCC green sheets by using a conductive paste for internal electrodes, and stacking the first and second internal electrode layers to form an MLCC laminate; preparing a plurality of green sheet for multi-layered ceramic varistors (MLV) using a second dielectric material having ZnO as a main ingredient, forming third and fourth internal electrode layers on the surface of each of the plurality of MLV green sheets by using a conductive paste for internal electrodes, and stacking the third and fourth internal electrode layers to form an MLV laminate; forming a plurality of MLCC green chips and a plurality of MLV green chips by compressing and cutting the MLCC laminate and the MLV laminate, respectively; exposing the rear end portions of the first to fourth internal electrode layers, respectively, by polishing the plurality of MLCC green chips and the plurality of MLV green chips; after burning out and sintering the plurality of MLCC green chips and the plurality of MLV green chips, respectively, forming an MLCC sintering chip having first and second internal electrodes arranged such that the front end portions thereof cross each other inside a first dielectric layer and an MLV sintering chip having third and fourth internal electrodes arranged inside a second dielectric layer arranged such that the front ends thereof are spaced apart from each other and face each other in the same plane; bonding the MLCC sintering chip and the MLV sintering chip with each other by using an insulating heat dissipation ceramic adhesive; and forming first and second external electrodes which electrically connect the MLCC sintering chip and the MLV sintering chip in parallel by respectively connecting the plurality of first and second internal electrodes exposed to both ends of the MLCC sintering chip with the plurality of third and fourth internal electrodes exposed to both ends of the MLV sintering chip, wherein an adhesive layer formed between the MLCC sintering chip and the MLV charcoal sintering chip by the insulating heat dissipation ceramic adhesive includes a partial bonding structure in which a plurality of bonding portions to which the insulating heat dissipation ceramic adhesive is applied, and a plurality of gap forming portions for minimizing heat generated from the multi-layered ceramic varistor from being transferred to the multi-layered ceramic capacitor and absorbing the heat generated from the multi-layered ceramic varistor when volume expansion is performed due to a difference in thermal expansion coefficients between the multi-layered ceramic capacitor and the multi-layered ceramic varistor, are arranged between the plurality of bonding portions, and the plurality of bonding portions are formed in a range of 70% to 95% of the total bonding surface.

In this case, the forming of the first and second external electrodes may include: forming a first electrode for electrically connecting the first internal electrode of the multi-layered ceramic capacitor and the third internal electrode of the multi-layered ceramic varistor in parallel with each other, and a second electrode for electrically connecting the second internal electrode of the multi-layered ceramic capacitor and the fourth internal electrode of the multi-layered ceramic varistor in parallel with each other; and forming a first plating layer formed on an outer surface of the first electrode and a second plating layer formed on an outer surface of the second electrode, wherein each of the first and second electrodes may form a partial electrode in a range in which heat generated from the multi-layered ceramic varistor does not affect the electrical connection with the first to fourth internal electrodes while minimizing the transfer of heat generated from the multi-layered ceramic varistor to the multi-layered ceramic capacitor through the first and second external electrodes.

In addition, the first electrode may include all layers of the first internal electrode of the multi-layered ceramic capacitor, cover 70% to 100% of the entire length of the first dielectric layer, include all layers of the third internal electrode of the multi-layered ceramic varistor, and cover 70% to 100% of the total length of the second dielectric layer, and the second electrode may include all layers of the second internal electrode of the multi-layered ceramic capacitor, cover 70% to 100% of the entire length of the first dielectric layer, include all layers of the fourth internal electrode of the multi-layered ceramic varistor, and cover 70% to 100% of the total length of the second dielectric layer.

Moreover, the first and second external electrodes are respectively formed at one side and the other end portions of an assembly in which the multi-layered ceramic capacitor and the multi-layered ceramic varistor are assembled, and the manufacturing method may further include: an insulation and moisture-resistant coating impregnation step in which, after the first and second electrodes are formed, a parylene or silicon coating is performed in a vacuum impregnation method on the outer surface of the assembly; and a step of forming first and second electrodes by performing a barrel polishing process before forming first and second plating layers on outer surfaces of the first and second electrodes, respectively, after performing the insulation and moisture-resistant coating impregnation step.

The burning out and sintering of the plurality of MLCC green chips and the plurality of MLV green chips may include burning out the plurality of MLCC green chips and the plurality of MLV green chips at a temperature of about 200° C. to about 250° C. for about 40 hours to about 80 hours, and then sintering the plurality of MLCC green chips and the plurality of MLV green chips at a temperature of about 1200° C. to about 1260° C. under a reduction atmosphere.

### BRIEF DESCRIPTION OF THE DRAWINGS

FIG. 1 is a perspective view illustrating a composite device for automotive electric parts according to a preferred embodiment of the present disclosure.

FIG. 2 is a longitudinal cross-sectional view of the composite device for automotive electric parts shown in FIG. 1.

FIGS. 3A to 3C are cross-sectional views respectively illustrating an assembly in which an MLCC laminate, an MLV laminate, and an assembly in which an MLCC sintering chip and an MLV sintering chip are bonded to each other in a manufacturing process of manufacturing a composite device for automotive electric parts according to the present disclosure.

FIGS. 4A and 4B are plan views respectively illustrating bonding patterns of an adhesive layer when the MLCC sintering chips and the MLV sintering chips are bonded in FIG. 3C.

FIG. 5 is a side view of an assembly in which an MLCC sintering chip and an MLV sintering chip are integrally assembled using an adhesive layer in a process of manufacturing a composite device for automotive electric parts according to the present disclosure.

FIG. 6 is a side view of an assembly showing a formation range of a partial external electrode in a process of manufacturing a composite device for automotive electric parts according to the present disclosure.

FIG. 7 is a flowchart illustrating a method of manufacturing a composite device for automotive electric parts according to an embodiment of the present disclosure.

### DETAILED DESCRIPTION OF THE INVENTION

Hereinafter, embodiments of the present disclosure will be described in detail with reference to the accompanying drawings.

The sizes and shapes of the components shown in the drawings may be exaggerated for clarity and convenience. In addition, terms defined in consideration of the configuration and operation of the present disclosure may vary depending on the intention or custom of the user, the operator, and the like. Definitions of these terms should be based on the content of this specification.

In consideration of the fact that a composite device for automotive electric parts according to the present disclosure is a chip in which a multi-layered ceramic varistor (MLV) is merged with a multi-layered ceramic capacitor (MLCC), and is used for an electric vehicle that employs a battery having a high rated voltage, the distance between the internal electrodes of the MLV may be adjusted to be different from the distance between the internal electrodes for the MLCC so as to have an operation voltage of the MLV in response to a breakdown voltage (BDV) of the MLCC having a high capacity. When the distance between the internal electrodes of the MLV is changed, for example, from 15 μm to 1,000 μm, the operation voltage of the MLV may increase from 4.5 V to 300 V.

In addition, in the present disclosure, the MLCC sintering chip and the MLV sintering chip, in which the internal electrodes are formed and the external electrodes are not formed, are bonded by using a ceramic adhesive having excellent heat dissipation characteristics, and then the partial external electrodes are formed only in the partial area where internal electrodes of the MLCC and the MLV are connected, thereby implementing an electrical parallel connection and thus minimizing the transmission of heat generated from the MLV to the MLCC due to the heat generation of the MLV.

The composite device for automotive electric parts according to the present disclosure is a single chip in which an MLV is merged with an MLCC, and thus, the electrical stress applied to the MLCC when the overvoltage is applied may be effectively mitigated by the electrical parallel connection structure, according to the turn-on operation of the MLV connected in parallel to the MLCC, which may improve the reliability and durability of the MLCC.

When static electricity is introduced, the MLV may be turned on because the voltage of the static electricity is greater than the breakdown voltage (Vbr) to allow the static electricity to pass therethrough. In addition, when a leakage current by an external power source is introduced, a breakdown voltage (Vbr) is greater than a rated voltage of the external power source, thereby blocking a leakage current.

The MLCC constituting the composite device for automotive electric parts includes a device including BaTiO₃ as a main ingredient, and is required to satisfy the temperature characteristics of X7R, X5R, X8R, X9R, and X9R, the electrostatic capacity of 0.1 μF to 100 μF, and the rated voltage of 6.3 V to 3 kV. The MLV is a device including ZnO as a main ingredient, and is required to satisfy a rated voltage of 8 V to 680 V, a clamping voltage of 20 V to 1 kV, and a capacitance of 5 pF to 0.01 μF.

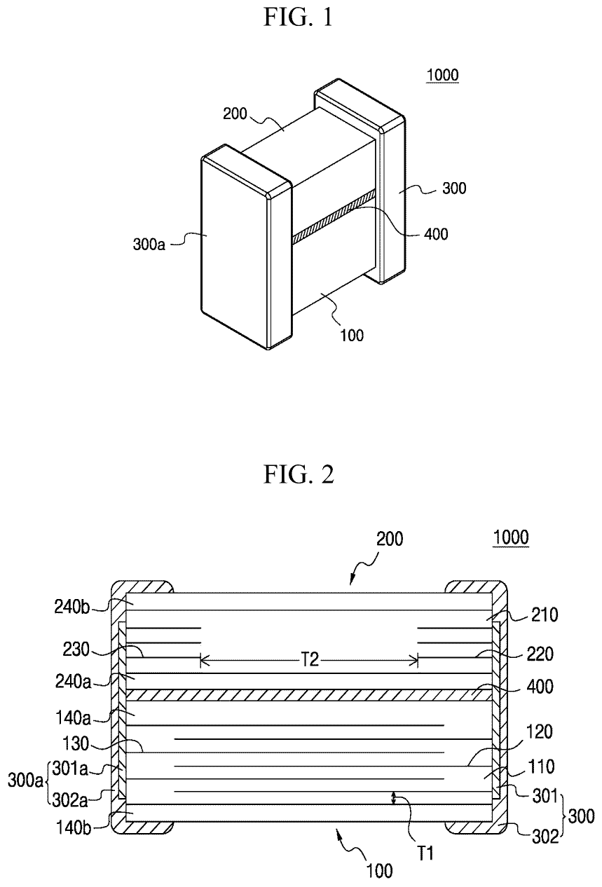

FIG. 1 is a perspective view illustrating a composite device for automotive electric parts according to a preferred embodiment of the present disclosure, and FIG. 2 is a longitudinal cross-sectional view of the composite device for automotive electric parts shown in FIG. 1.

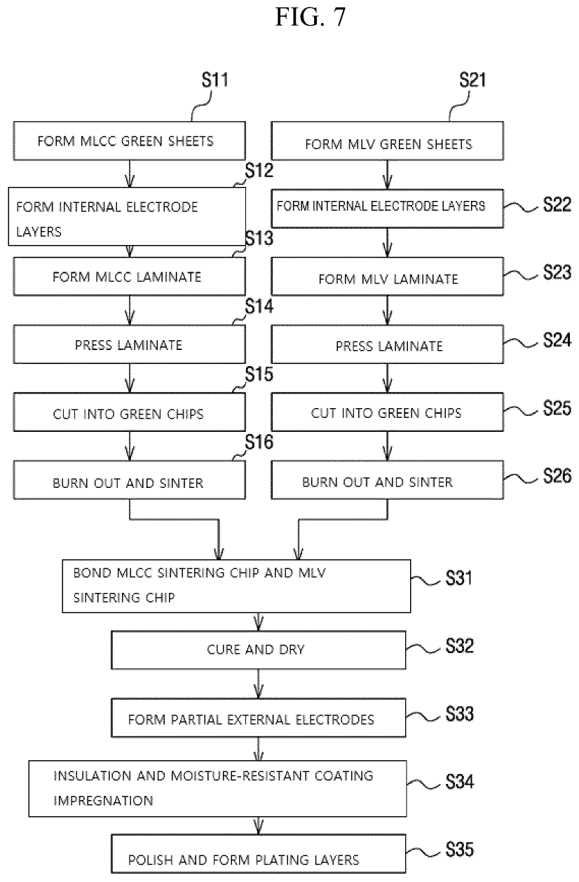

FIG. 7 is a flowchart illustrating a method of manufacturing a composite device for automotive electric parts according to an embodiment of the present disclosure.

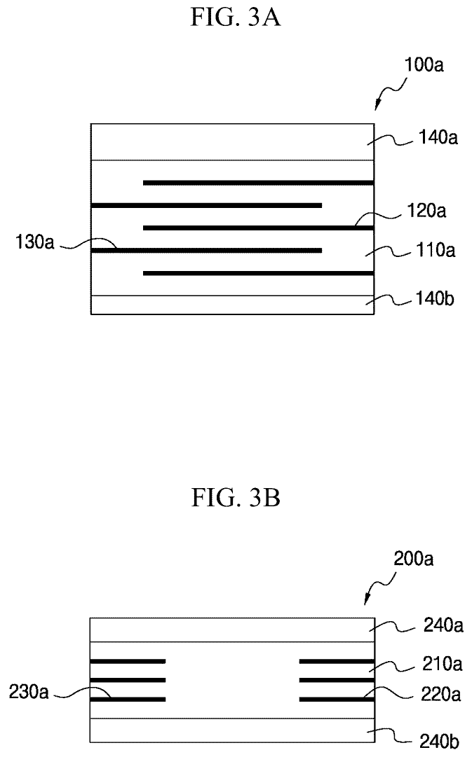

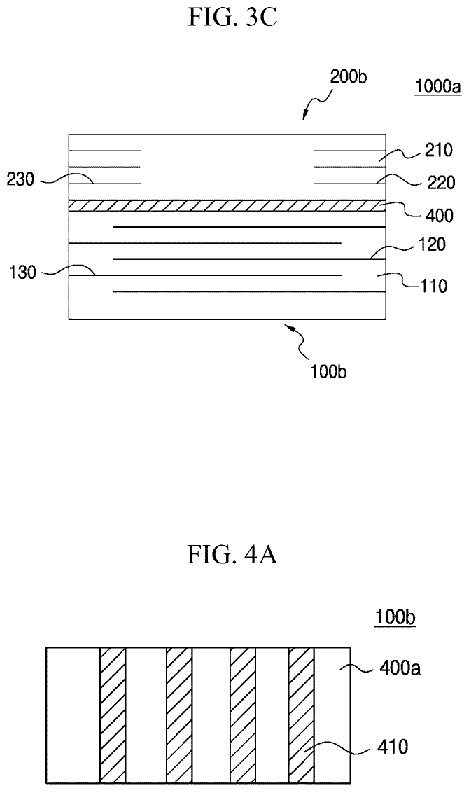

First, referring to FIGS. 1 and 2, a composite device 1000 for automotive electric parts according to a preferred embodiment of the present disclosure includes an MLCC 100, an MLV 200, an adhesive layer 400 for bonding the MLCC 100 and the MLV 200, and a pair of external electrodes 300 and 300a which are respectively formed at both ends of an assembly 1000a (see FIGS. 3C and 5) of the MLCC 100 and the MLV 200.

The MLCC 100 includes a first dielectric layer 110, and first and second internal electrodes 120 and 130 alternately arranged with the first dielectric layer 110 therebetween, and the MLV 200 includes a second dielectric layer 210, and third and fourth internal electrodes 220 and 230 which are respectively arranged on both sides of the second dielectric layer 210 to face each other.

Hereinafter, a method of manufacturing a composite device 1000 for automotive electric parts according to a preferred embodiment of the present disclosure will be described with reference to FIGS. 1 to 7.

First, in order to fabricate an MLCC 100, after preparing a plurality of MLCC green sheets 110a, first and second internal electrode layers 120a and 130a are formed on respective surfaces thereof, and the first and second internal electrode layers 120a and 130a are laminated to form an MLCC laminate 100a (S11 to S13).

In FIGS. 3A and 3B, the plurality of MLCC green sheets 110a may include, for example, 113 layers, and the plurality of MLV green sheets 200a may include, for example, 20 layers, and for convenience of description, a plurality of green sheets are not discriminatively illustrated in the drawings.

Referring to FIG. 3A, after forming the MLCC laminate 100a, the plurality of MLCC green sheets 110a are sintered in a subsequent process to form a single first dielectric layer 110. In addition, referring to FIG. 3B, after forming the MLV laminate 200a, the plurality of the MLV green sheets 210a are sintered in a subsequent process to form a single second dielectric layer 210.

The first dielectric material for forming each of the plurality of MLCC green sheets 110a is capable of obtaining a sufficient capacitance, but not particularly limited thereto and may include, for example, BaTiO₃ as a main ingredient.

A first dielectric raw material forming the MLCC green sheet 110a may be obtained by adding various ceramic additives, organic solvents, plasticizers, binders, dispersants, and the like to a powder such as barium titanate (BaTiO₃), according to the purpose of the present disclosure.

According to a specific example of the first dielectric material, after forming a slurry including at least one metal oxide of Ni, Ca, Dy, Mn, Si, V, Cr, and Ca together with BaTiO₃, then the slurry is coated on a carrier film (not shown) and dried to form the MLCC green sheet 110a (S11).

When the plurality of MLCC green sheets 110a are formed, the first and second internal electrode layers 120a and 130a are respectively formed on the surfaces of the green sheets by using the conductive paste for internal electrodes. The conductive paste for internal electrodes for forming the first and second internal electrode layers 120a and 130a may include at least one of Ni, Ag, Ag—Pd, and Pt. For example, when the conductive paste for the internal electrode is formed using Ni, the first and second internal electrode layers 120a and 130a are formed to have the conductive paste for the internal electrodes on the surfaces of the green sheets by a screen printing method (S12).

When the first and second internal electrode layers 120a and 130a are formed on the surfaces of the plurality of MLCC green sheets 110a, respectively, as shown in FIG. 3A, the MLCC laminate 100a is formed by stacking the plurality of MLCC green sheets 110a such that the front ends of the first and second internal electrode layers 120a and 130a cross each other (S13).

Furthermore, a plurality of first dielectric layers on which the internal electrode layers 120a and 130a are not formed may be stacked on upper and lower portions of the MLCC laminate 100a to include first and second cover layers 140a and 140b, respectively. The first and second cover layers 140a and 140b may serve to maintain the reliability of a capacitor against an external impact, as will be described later.

Referring to FIG. 3B, in order to fabricate an MLV 200, after preparing a plurality of MLV green sheets 210a, third and fourth internal electrode layers 220a and 230a are formed on respective surfaces thereof, and the third and fourth internal electrode layers 220a and 230a are laminated to form an MLV laminate 200a (S21 to S23).

The second dielectric material for forming each of the plurality of MLV green sheets 210a may include, for example, ZnO as a main ingredient. According to a specific example, the second dielectric material may include at least one of oxides of Zr, Nb, Pr, Bi, Co—Si, Cr, and Mn together with the main ingredient ZnO.

The ZnO-based varistor composition is mixed with a solvent, dried, and pulverized to obtain starting raw material powder, and then the starting raw material powder is molded to form a plurality of MLV green sheets 210a (S21). The third and fourth internal electrode layers 220a and 230a are formed on the surfaces of the plurality of MLV green sheets 210a by a screen printing method (S22), and known electrode materials such as Ag, Pd, Pt, Ag—Pd, and the like may be used as the electrode material. In the case of the Ag—Pd alloy, a weight ratio of 7:3 may be achieved.

In this case, the third and fourth internal electrode layers 220a and 230a may be arranged on the same plane in each of the plurality of MLV green sheets 210a, and the front ends of the third and fourth internal electrode layers 220a and 230a may be simultaneously formed to be spaced apart from each other by a predetermined interval to face each other.

The composite device 1000 for automotive electric parts according to the present disclosure adjusts the operating voltage of the MLV 200 by using the distance between the internal electrodes according to the breakdown voltage BDV of the MLCC 100.

For example, a distance (T1) between the plurality of first internal electrodes 120 and the plurality of second internal electrodes 130 of the MLCC 100 is set to, for example, 14 μm, and a distance (T2) between the plurality of third internal electrodes 220 and the plurality of fourth internal electrodes 230 of the MLV 200 is changed from, for example, 15 μm to 1,000 μm. As a result, the operation voltage of the MLV 200 may increase from 4.5 V to 8V to 680 V.

In general, the capacitor formed in the MLCC form is designed to have a distance (T1) between the internal electrodes, for example, 9 μm. However, in the composite device 1000 for automotive electric parts according to the present disclosure, for example, the distance (T1) between the plurality of first internal electrodes 120 and the plurality of second internal electrodes 130 may be increased from 9 μm to 14 μm in consideration of the fact that the composite device 1000 is used for automotive electric parts using a battery that supplies a high energy of a high current and a high voltage of the rated voltage of DC 50 V.

As described above, when the third and fourth internal electrode layers 220a and 230a are formed on the surfaces of the plurality of MLV green sheets 210a, respectively, the MLV laminate 200a is formed by stacking the plurality of MLV green sheets 210a such that the third and fourth internal electrode layers 220a and 230a face each other (S23).

In this case, third and fourth cover layers 240a and 240b may be formed by stacking second dielectric layers on which internal electrode layers are not formed, respectively, on the upper and lower portions of the MLV laminate 200a.

Subsequently, both the MLCC laminate 100a and the MLV laminate 200a are subjected to isostatic pressing (S14 and S24), and then cut into a plurality of green chips of a preset size (S15 and S25).

Thereafter, the plurality of green chips that are formed by cutting the MLCC laminate 100a and the plurality of green chips that are formed by cutting the MLV laminate 200a are rounded by barrel polishing, respectively, and the rear end portions of the first and second internal electrode layers 120a and 130a and the third and fourth internal electrode layers 220a and 230a may be exposed in the longitudinal direction of the green chips.

Subsequently, the plurality of green chips which are formed by cutting the MLCC laminate 100a and the plurality of green chips which are formed by cutting the MLV laminate 200a are burned out, and then sintered to form an MLCC sintering chip and an MLV sintering chip (S16 and S26).

The burn-out of the green chips is maintained for 40 to 80 hours at a temperature of 200° C. to 250° C. in an atmospheric condition to burn out the green chips at the same time. Thereafter, the burn-out completed green chips are sintered at 1200° C. to 1260° C. in a reduction atmosphere.

In the MLCC sintering chip 100b and the MLV sintering chip 200b, which have been sintered as described above, the plurality of MLCC green sheets 110a form a first dielectric layer 110, the plurality of MLV green sheets 210a form a second dielectric layer 210, the first and second internal electrode layers 120a and 130a form first and second internal electrodes 120 and 130, and the third and fourth internal electrode layers 220a and 230a form third and fourth internal electrodes 220 and 230.

After the MLCC sintering chip 100b and the MLV sintering chip 200b are formed as described above, as shown in FIG. 3C, a first cover layer 140a of the MLCC sintering chip 100b and the third cover layer 240a of the MLV sintering chip 200b are bonded using a ceramic adhesive with excellent heat dissipation characteristics to achieve surface bonding (S31).

FIG. 3C is a cross-sectional view illustrating an assembly 1000a in which the MLCC sintering chip 100b and the MLV sintering chip 200b are bonded. In the MLCC sintering chip 100b and the MLV sintering chip 200b, the first to fourth cover layers 140a, 140b, 240a, and 240b are integrated with the first dielectric layer 110 and the second dielectric layer 210 and thus are not separately illustrated.

An adhesive layer 400 formed by bonding the MLCC sintering chip 100b and the MLV sintering chip 200b is preferably formed to have a thickness of 1/50 to 1/100 (for example, 3 to 15 μm) of the MLCC sintering chip 100b, and is dried after being cured at a temperature of 200° C. to 400° C. for 30 minutes to 4 hours (S32), thereby increasing adhesion between the MLCC sintering chip 100b and the MLV sintering chip 200b.

Ceramic adhesives with excellent heat dissipation properties used to increase adhesion between the MLCC 100 and the MLV 200 include, for example, glass, a polymer matrix serving as a binder, and an insulating heat dissipation filler made of ceramic that is added to and dispersed in a polymer matrix by 1 to 10 wt % to improve thermal conductivity, and insulating heat dissipation ceramic adhesives that are cured by ultraviolet (UV) curing or thermal curing may be used. In this case, the insulating heat dissipation ceramic adhesive may further include an additive such as a curing agent.

The polymer matrix may be formed by crosslinking an organic compound known as an epoxy-based, polyimide (PI)-based, urethane-based, acrylic-based, ester-based, etc. having a temperature stability of 250° C. to 500° C., through a curing agent, and the specific type thereof is not particularly limited in the present disclosure. For example, when the epoxy-based component is used, an epoxy component, a curing agent, a glass filler, and a solvent may be included.

The insulating heat dissipation filler includes a ceramic having an excellent heat dissipation constant, which has a thermal conductivity of 3 W/mK or greater, and may include at least one selected from the group consisting of aluminum oxide (Al₂O₃), silicon nitride (Si₃N₄), aluminum nitride (AlN), magnesium oxide (MgO), titanium nitride (TiN), boron nitride (BN), titanium dioxide (TiO₂), zinc oxide (ZnO), and silicon dioxide (SiO₂). An average particle diameter of the insulating heat dissipation filler may be in a range of 0.1 μm to 10 μm.

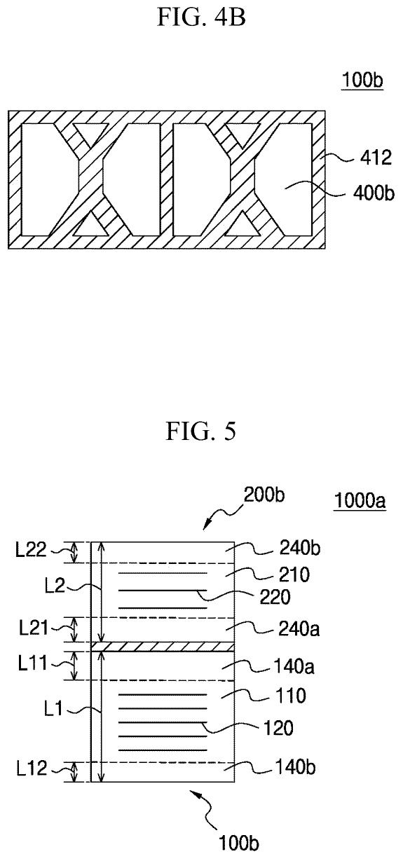

In this case, as in the embodiments illustrated in FIGS. 4A and 4B, the adhesive layer 400 formed between the MLCC 100 and the MLV 200 has a partial bonding structure in which gap forming portions 410 and 412 formed in a linear, circular, or polygonal shape are arranged between the bonding portions 400a and between the bonding portions 400b, respectively, rather than being formed on the entire bonding surface where the MLCC 100 and the MLV 200 are in contact with each other.

For example, the adhesive layer 400 of the partial bonding structure according to the embodiment illustrated in FIG. 4A may have, in a stripe shape, a plurality of gap forming portions 410 in which an adhesive layer is not formed between the bonding portions 400a, and the adhesive layer 400 of the partial bonding structure according to the embodiment illustrated in FIG. 4B may have, in a polygonal shape, a plurality of gap forming portions 412, in which an adhesive layer is not formed between the bonding portions 400b.

As shown in FIG. 4A, the adhesive layer 400 having a partial bonding structure in which the plurality of gap forming portions 410 are arranged between the bonding portions 400a may be formed on the upper surface of the MLCC 100 by a screen or dispensing method. As shown in FIG. 4B, the adhesive layer 400 having a partial bonding structure in which the plurality of gap forming portions 412 are arranged between the bonding portions 400b may be formed on the upper surface of the MLCC 100 by the screen or dispensing method.

When the adhesive layer 400 formed between the MLCC 100 and the MLV 200 includes a plurality of gap forming parts 410 (or 412), it is possible to minimize the transfer of heat generated from the MLV to the MLCC, and when the volume expansion is performed due to the difference between the thermal expansion coefficients of the MLCC 100 and the MLV 200, it is possible to prevent cracks from occurring due to thermal shock and mechanical impact on the MLCC 100.

In particular, when the adhesive layer 400 includes the plurality of gap forming portions 410 (or 412), the heat generated from the MLV may not be uniformly transmitted to the MLCC, and the adhesive layer 400 may prevent heat transfer to a specific portion (region).

Furthermore, the insulating heat dissipation filler made of ceramic having excellent heat dissipation coefficient included in the insulating heat dissipation ceramic adhesive may rapidly diffuse the heat generated from the MLV to the periphery to prevent heat transfer to a specific portion (region).

Considering the above, it is preferable that the adhesive layer 400 having a partial bonding structure is formed to have the area of the bonding portions 400a (or 400b) in a range of 70% to 95% when compared with the area of the entire bonding surface.

When the area of the bonding portions 400a (or 400b) is less than 70%, volume expansion is performed due to a difference between thermal expansion coefficients of the MLCC 100 and the MLV 200, and in this case, it is difficult to prevent cracks from occurring due to thermal shock and mechanical impact on the MLCC 100, and when the area of the bonding portions 400a (or 400b) exceeds 95%, it is difficult to minimize the transfer of heat generated from the MLV to the MLCC.

In addition, when the area of the bonding portions 400a (or 400b) is less than 70%, a void may be generated during volume expansion of the MLV 200 to generate insulation breakdown, and when the area of the bonding portions 400a (or 400b) exceeds 95%, heat transfer deformation may occur. Accordingly, and the area of the bonding portions 400a (or 400b) may be set in consideration of the heat dissipation coefficient of the insulating heat dissipation filler.

The rear end portions of the first and second internal electrode layers 120a and 130a and the third and fourth internal electrode layers 220a and 230a are exposed in the longitudinal direction of each green chip by barrel-polishing the plurality of green chips formed by cutting the MLCC laminate 100a and the plurality of green chips formed by cutting the MLV laminate 200a.

Therefore, an assembly 1000a in which the MLCC sintering chip 100b and the MLV sintering chip 200b shown in FIG. 3C are bonded has a state in which the first and second internal electrodes 120 and 130 are exposed at both ends of the MLCC sintering chip 100b, and the third and fourth internal electrodes 220 and 230 are exposed at both ends of the MLV sintering chip 200b.

FIG. 5 is a side view of an assembly 1000a showing a state in which an MLCC sintering chip 100b and an MLV sintering chip 200b are integrally assembled as a single body by using an adhesive layer 400 in a process of manufacturing a composite device for electric parts according to the present disclosure, which shows a state before forming an external electrode.

Since a composite device 1000 for electric parts is formed by using the assembly 1000a which is formed by integrally assembling the MLCC sintering chip 100b and the MLV sintering chip 200b as a single body by using the adhesive layer 400, it is preferable that a thickness L11 of a first cover layer 140a and a thickness L12 of a second cover layer 140b respectively formed at the upper portion and the lower portion of the MLCC sintering chip 100b, which are bonded to the MLV sintering chip 200b, are set to 15% to 30% and 5% to 10%, respectively, with respect to the entire length L1, in the vertical direction.

In addition, a thickness L21 of a third cover layer 240a and a thickness L22 of a fourth cover layer 240b respectively formed on the lower portion and the upper portion of the MLV sintering chip 200b, which are bonded to the MLCC sintering chip 100b, are preferably set to 15% to 30% and 5% to 10% with respect to the total length L2, in the vertical direction, respectively, and may vary according to the capacity of the MLV 200.

Thereafter, as shown in FIGS. 1 and 2, first and second external electrodes 300 and 300a are formed at both ends of the assembly 1000a to electrically connect the MLCC 100 with the MLV 200 in parallel.

The first external electrode 300 formed at one end portion of the assembly 1000a includes a first electrode 301 for electrically connecting the first internal electrode 120 of the MLCC sintering chip 100b to the third internal electrode 220 of the MLV sintering chip 200b in parallel, and a first plating layer 302 formed on the outer surface of the first electrode 301, and the second external electrode 300a formed at the other end portion of the assembly 1000a includes a second electrode 301a for electrically connecting the second internal electrode 130 of the MLCC sintering chip 100b to the fourth internal electrode 230 of the MLV sintering chip 200b in parallel, and a second plating layer 302a formed on the outer surface of the second electrode 301a.

According to a conventional art of forming an external electrode, a conductive paste in which a conductive metal is mixed with a binder component is coated to cover both side ends of a sintering chip by a predetermined length according to a conventional method such as dipping.

When the external electrodes are formed by performing a coating to cover both side ends of the sintering chip by a predetermined length, heat generated from the MLV may be transferred to the MLCC through the external electrodes, and thus thermal cracks due to non-uniformity of heat transfer may occur between the external electrodes surrounding both side ends of the sintering chip and the ceramic.

Accordingly, in the present disclosure, the first and second electrodes 301 and 301a provide a method of forming a partial external electrode in a range that does not affect the electrical connection with the first to fourth internal electrodes 120, 130, 220, and 230 while minimizing the transfer of heat generated from the MLV to the MLCC through the external electrodes.

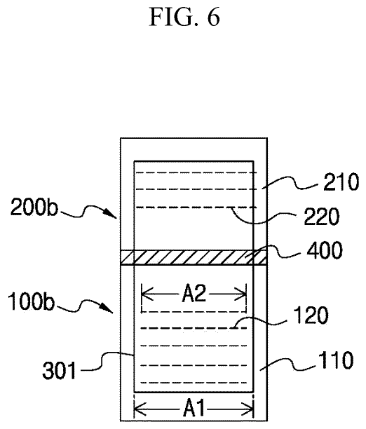

FIG. 6 is a side view of an assembly showing a formation range of a partial external electrode in a process of manufacturing a composite device for automotive electric parts according to the present disclosure.

The first and second electrodes 301 and 301a according to the present disclosure are partially formed only in a partial area of both side surfaces required for electrical connection between the first to fourth internal electrodes 120, 130, 220, and 230 of the MLCC sintering chip 100b and the MLV quenching chip 200b using a deposition method such as a sputtering method, an atomic layer deposition (ALD) method, an evaporation deposition method, or a printing method (S33).

Specifically, as shown in FIGS. 2 and 6, the first electrode 301 includes all layers of the first internal electrode 120 in the case of the MLCC sintering chip 100b, and covers 70% to 100% of the entire length of the ceramic body referring to the first dielectric layer 110, and the first electrode 301 includes all layers of the third internal electrode 220 in the case of the MLV sintering chip 200b, and covers 70% to 100% of the entire length of the ceramic body referring to the second dielectric layer 210.

In addition, as shown in FIGS. 2 and 6, the second electrode 301a includes all layers of the second internal electrode 130 in the case of the MLCC sintering chip 100b, similarly to the first electrode 301, and covers 70% to 100% of the entire length of the ceramic body referring to the first dielectric layer 110, and the second electrode 301a includes all layers of the fourth internal electrode 230 in the case of the MLV sintering chip 200b, and covers 70% to 100% of the entire length of the ceramic body referring to the second dielectric layer 210.

When the first and second electrodes 301 and 301a are partially formed only in partial areas of both sides required for electrical connection with the first to fourth internal electrodes 120, 130, 220, and 230, The width A1 of the first and second electrodes 301 and 301a may be set to satisfy 0.8×A2<A1<1.2×A2 as compared with the width A2 of the first to fourth internal electrodes 120, 130, 220, and 230.

When the width A1 of the first and second electrodes 301 and 301a is less than 0.8×A2, the contact area between the first and second electrodes 301 and 301a and the first to fourth internal electrodes 120, 130, 220, and 230 decreases, and thus adhesion is deteriorated and equivalent series resistance (ESR) is increased.

In addition, when the width A1 of the first and second electrodes 301 and 301a exceeds 1.2×A2, cracks may occur due to mechanical impact when volume expansion due to a difference in thermal expansion coefficients between the MLCC and the MLV occurs.

For example, the first and second electrodes 301 and 301a may be formed by a deposition method using a metal such as Ag, Al, Cu, TiN, or the like, and the deposition thickness may be preferably set to a range of 0.1 μm to 5.0 μm.

As shown in FIGS. 2 to 6, instead of covering the entire side surface of the assembly 1000 (or 1000a), the first and second electrodes 301 and 301a are partially formed only in the partial areas of both side surfaces required for electrical connection between the first to fourth internal electrodes 120, 130, 220, and 230 of the MLCC sintering chip 100b and the MLV sintering chip 200b.

As described above, in the present disclosure, the first and second electrodes 301 and 301a are partially formed only in the partial areas of both side surfaces required for electrical connection with the first to fourth internal electrodes 120, 130, 220, and 230, and thus, as the heat generated from the MLV 200 is transferred to the MLCC 100 through the external electrodes 300 and 300a, a crack phenomenon of the external electrodes surrounding both side ends of the sintering chip may be prevented.

In general, the outer portion of the MLCC has high insulation properties, and the MLV is made of a material through which current is well conducted. Therefore, the outer portion of the MLV has poor insulation properties.

Subsequently, when the first and second plating layers 302 and 302a are formed on the outer surfaces of the first and second electrodes 301 and 301a, respectively, an insulation and moisture-resistant coating impregnation process may be performed as a pretreatment process for preventing a bridge phenomenon from occurring.

To this end, in the present disclosure, an insulation and moisture-resistant coating impregnation process is performed, in which parylene or silicon coating is performed in a vacuum impregnation method on the outer surface of the assembly 1000 (or 1000a) to form a thin film on the outer surface of the assembly 1000 (or 1000a) (S34).

After the insulation and moisture-resistant coating impregnation process (S34) is performed, a barrel polishing process is performed before the first and second plating layers 302 and 302a are formed on outer surfaces of the first and second electrodes 301 and 301a, respectively, and thus, a pretreatment process for performing electroplating for deriving the first and second electrodes 301 and 301a is performed, and first and second plating layers 302 and 302a are formed (S35).

The first external electrode 300 and the second external electrode 300a are preferably prefabricated by forming first and second plating layers 302 and 302a on outer surfaces of the first and second electrodes 301 and 301a, respectively, in order to further improve ease of soldering and electrical connectivity when the composite device for electric parts is mounted on a circuit board in a flow soldering method or the like.

The first and second plating layers 302 and 302a may be formed using a conventional plating method, and may include at least one of metals such as nickel (Ni), tin (Sn), copper (Cu), tin lead alloys, and the like.

The first and second plating layers 302 and 302a may be formed in multiple layers by sequentially performing Ni plating and Sn plating to cover the surfaces of the first and second electrodes 301 and 301a, for example, using a wet barrel plating method. In addition, the first and second plating layers 302 and 302a may be formed of a Ni-plated layer or a Sn-plated layer, or may be formed as multiple layers of a Ni-plated layer and a Sn-plated layer.

In addition, the composite device 1000 (or 1000a) for electric parts according to the preferred embodiment of the present disclosure may form an overcoat layer on the outer surface of the composite device 1000 (or 1000a) except for the first external electrode 300 and the second external electrode 300a, as needed, by using an impregnation process in an impregnation solution containing silicon. By forming the overcoat layer, it is possible to prevent a surface discharge phenomenon caused by a surface flash over, thereby improving the reliability of a product.

In the embodiments described above, a structure of a composite device 1000 (or 1000a) for electric parts in which one MLCC and one MLV are stacked has been described as an example, but the present disclosure is not limited thereto and may be applied in a stacked structure such as a MLV/MLCC/MLV, a MLCC/MLV/MLCC, or the like.

While the present disclosure has been particularly shown and described with reference to exemplary embodiments thereof, by way of illustration and example only, it is clearly understood that the present disclosure is not to be construed as limiting the present disclosure, and various changes and modifications may be made by those skilled in the art within the protective scope of the invention without departing off the spirit of the present disclosure.

The composite devices for electric parts according to the present disclosure may be used as electric parts such as a vehicle battery line, a control device of a vehicle, a sensor, an actuator, a filtering, an electric/electronic subsystem, and the like.

As described above, the present disclosure is a composite device for automotive electric parts using advantages of MLCCs and MLVs, which contributes for noise reduction, DC ripple current reduction, and voltage stabilization from frequency-impedance characteristics.

In the present disclosure, a multi-layered ceramic capacitor (MLCC) sintering chip and a multi-layered ceramic varistor (MLV) sintering chip on each of which an internal electrode is formed and an external electrode is not formed are bonded with each other by using a ceramic adhesive having excellent heat dissipation characteristics, and then a first external electrode is formed only in a partial area where the internal electrodes of the MLCC and the MLV are connected to implement a parallel connection, thereby minimizing the transfer of heat generated from the MLV to the MLCC.

In addition, in the present disclosure, a crack may be prevented from being generated between an external electrode and a ceramic body due to non-uniformity of heat transfer from an MLV sintering chip when an MLCC sintering chip and the MLV sintering chip are bonded using a ceramic adhesive.

In the present disclosure, a product that is optimal for the characteristics of the multi-layered ceramic capacitor (MLCC) and the characteristics of the multi-layered ceramic varistor (MLV) may be manufactured, and then the product may be connected in parallel to provide a composite device for automotive electric parts having desired characteristics.

In the related art, there is proposed a composite device in which a varistor and an MLCC are bonded and adhered in a state in which external electrodes of each of the MLV and the MLCC are formed, but in the present disclosure, a varistor and an MLCC in which an external electrode is not formed are bonded to each other by a ceramic adhesive when manufacturing the varistor and the MLCC.

The present disclosure may provide a composite device for automotive electric parts bonded by using a ceramic adhesive capable of adjusting the operating voltage of an MLV to a distance between the internal electrodes according to the breakdown voltage (BDV) of an MLCC, and preventing thermal shock between the MLCC and the MLV.

What is claimed

1. A composite device for automotive electric parts, comprising:
a multi-layered ceramic capacitor including a first dielectric layer having barium titanate (BaTiO₃) as a main ingredient and a plurality of first and second internal electrodes alternately arranged such that front end portions thereof cross each other with the first dielectric layer therebetween;
a multi-layered ceramic varistor including a second dielectric layer having ZnO as a main ingredient, and a plurality of third and fourth internal electrodes arranged to face each other such that front end portions thereof are spaced apart from each other from both sides of a second dielectric layer, the multi-layered ceramic varistor being stacked on one side surface of the multi-layered ceramic capacitor;
an adhesive layer arranged between the multi-layered ceramic capacitor and the multi-layered ceramic varistor and made of an insulating heat dissipation ceramic adhesive for bonding the multi-layered ceramic capacitor and the multi-layered ceramic varistor;
and first and second external electrodes connecting the multi-layered ceramic capacitor and the multi-layered ceramic varistor in parallel by connecting the plurality of first and second internal electrodes exposed to both end portions of the multi-layered ceramic capacitor with the plurality of third and fourth internal electrodes exposed to both end portions of the multi-layered ceramic varistor, respectively, wherein
the adhesive layer has a partial bonding structure in which a plurality of bonding portions to which the insulating heat dissipation ceramic adhesive is applied, and a plurality of gap forming portions for minimizing heat generated from the multi-layered ceramic varistor from being transferred to the multi-layered ceramic capacitor and absorbing the heat generated from the multi-layered ceramic varistor when volume expansion is performed due to a difference in thermal expansion coefficients between the multi-layered ceramic capacitor and the multi-layered ceramic varistor, are arranged between the plurality of bonding portions, and
the plurality of bonding portions are formed in a range of 70% to 95% of the total bonding surface.

2. The composite device of claim 1, wherein the plurality of bonding portions are formed in any one of a linear shape, a circular shape, and a polygonal shape.

3. The composite device of claim 1, wherein the insulating heat dissipation ceramic adhesive comprises: a polymer matrix serving as a binder; and an insulating heat dissipation filler including a ceramic dispersed by adding 1 wt % to 10 wt % of the polymer matrix.

4. The composite device of claim 3, wherein
the polymer matrix comprises any one of epoxy-based, polyimide (PI)-based, urethane-based, acrylic-based, ester-based, and silicon-based polymers having a temperature stability of 250° C. to 500° C., and
the insulating heat dissipation filler comprises a ceramic having a thermal conductivity of about 3 W/mK or more, and an average particle diameter which are set to about 0.1 μm to about 10 μm.

5. The composite device of claim 1, wherein
each of the first and second external electrodes is formed at one side and the other side end portions of an assembly in which the multi-layered ceramic capacitor and the multi-layered ceramic varistor are assembled, and
the first external electrode includes a first electrode electrically connecting in parallel a first internal electrode of the multi-layered ceramic capacitor with a third internal electrode of the multi-layered ceramic varistor, and a first plating layer formed on an outer surface of the first electrode,
the second external electrode includes a second electrode electrically connecting in parallel a second internal electrode of the multi-layered ceramic capacitor with a fourth internal electrode of the multi-layered ceramic varistor, and a second plating layer formed on an outer surface of the second electrode, and
each of the first and second electrodes forms a partial electrode in a range in which heat generated from the multi-layered ceramic varistor does not affect the electrical connection with the first to fourth internal electrodes while minimizing the transfer of heat generated from the multi-layered ceramic varistor to the multi-layered ceramic capacitor through the first and second external electrodes.

6. The composite device of claim 5, wherein
the first electrode includes all layers of the first internal electrode of the multi-layered ceramic capacitor, covers 70% to 100% of the entire length of the first dielectric layer, includes all layers of the third internal electrode of the multi-layered ceramic varistor, and covers 70% to 100% of the total length of the second dielectric layer, and
the second electrode includes all layers of the second internal electrode of the multi-layered ceramic capacitor, covers 70% to 100% of the entire length of the first dielectric layer, includes all layers of the fourth internal electrode of the multi-layered ceramic varistor, and covers 70% to 100% of the total length of the second dielectric layer.

7. The composite device of claim 5, wherein the first and second electrodes are partially formed on only a partial area of both sides required for electrical connection with the first to fourth internal electrodes, and widths (A1) of the first and second electrodes are set to be in a range where 0.8×A2<A1<1.2×A2, and thicknesses of the first and second electrodes are set to 0.1 μm to 5 μm, respectively.

8. The composite device of claim 1, wherein the operating voltage of the multi-layered ceramic varistor is determined by adjusting a distance between the third internal electrode and the fourth internal electrode of the multi-layered ceramic varistor in consideration of the breakdown voltage (BDV) of the multi-layered ceramic capacitor.

9. The composite device of claim 1, wherein the adhesive layer has a thickness of 1/50 to 1/100 of the multi-layered ceramic capacitor.

10. A method of manufacturing a composite device for automotive electric parts, the manufacturing method comprising:
preparing a plurality of green sheet for multi-layered ceramic capacitors (MLCC) using a first dielectric material having barium titanate (BaTiO₃) as a main ingredient, forming first and second internal electrode layers on the surface of each of the plurality of MLCC green sheets by using a conductive paste for internal electrodes, and stacking the first and second internal electrode layers to form an MLCC laminate;
preparing a plurality of green sheet for multi-layered ceramic varistors (MLV) using a second dielectric material having ZnO as a main ingredient, forming third and fourth internal electrode layers on the surface of each of the plurality of MLV green sheets by using a conductive paste for internal electrodes, and stacking the third and fourth internal electrode layers to form an MLV laminate;
forming a plurality of MLCC green chips and a plurality of MLV green chips by compressing and cutting the MLCC laminate and the MLV laminate, respectively;
exposing the rear end portions of the first to fourth internal electrode layers, respectively, by polishing the plurality of MLCC green chips and the plurality of MLV green chips;
after burning out and sintering the plurality of MLCC green chips and the plurality of MLV green chips, respectively, forming an MLCC sintering chip having first and second internal electrodes arranged such that the front end portions thereof cross each other inside a first dielectric layer and an MLV sintering chip having third and fourth internal electrodes arranged inside a second dielectric layer arranged such that the front ends thereof are spaced apart from each other and face each other in the same plane;
bonding the MLCC sintering chip and the MLV sintering chip with each other by using an insulating heat dissipation ceramic adhesive, to form an adhesive layer; and
forming first and second external electrodes which electrically connect the MLCC sintering chip and the MLV sintering chip in parallel by respectively connecting the plurality of first and second internal electrodes exposed to both ends of the MLCC sintering chip with the plurality of third and fourth internal electrodes exposed to both ends of the MLV sintering chip, wherein
the adhesive layer has a partial bonding structure in which a plurality of bonding portions to which the insulating heat dissipation ceramic adhesive is applied, and a plurality of gap forming portions for minimizing heat generated from the multi-layered ceramic varistor from being transferred to the multi-layered ceramic capacitor and absorbing the heat generated from the multi-layered ceramic varistor when volume expansion is performed due to a difference in thermal expansion coefficients between the multi-layered ceramic capacitor and the multi-layered ceramic varistor, are arranged between the plurality of bonding portions, and
the plurality of bonding portions are formed in a range of 70% to 95% of the total bonding surface.

11. The manufacturing method of claim 10, wherein the forming of the first and second external electrodes comprises:
forming a first electrode for electrically connecting the first internal electrode of the multi-layered ceramic capacitor and the third internal electrode of the multi-layered ceramic varistor in parallel with each other, and a second electrode for electrically connecting the second internal electrode of the multi-layered ceramic capacitor and the fourth internal electrode of the multi-layered ceramic varistor in parallel with each other; and
forming a first plating layer formed on an outer surface of the first electrode and a second plating layer formed on an outer surface of the second electrode, wherein
each of the first and second electrodes forms a partial electrode in a range in which heat generated from the multi-layered ceramic varistor does not affect the electrical connection with the first to fourth internal electrodes while minimizing the transfer of heat generated from the multi-layered ceramic varistor to the multi-layered ceramic capacitor through the first and second external electrodes.

12. The manufacturing method of claim 11, wherein
the first electrode includes all layers of the first internal electrode of the multi-layered ceramic capacitor, covers 70% to 100% of the entire length of the first dielectric layer, includes all layers of the third internal electrode of the multi-layered ceramic varistor, and covers 70% to 100% of the total length of the second dielectric layer, and
the second electrode includes all layers of the second internal electrode of the multi-layered ceramic capacitor, covers 70% to 100% of the entire length of the first dielectric layer, includes all layers of the fourth internal electrode of the multi-layered ceramic varistor, and covers 70% to 100% of the total length of the second dielectric layer.

13. The manufacturing method of claim 11, wherein each of the first and second external electrodes is formed at one side and the other side end portions of an assembly in which the multi-layered ceramic capacitor and the multi-layered ceramic varistor are assembled, and the manufacturing method further comprises:
an insulation and moisture-resistant coating impregnation step in which the multi-layered ceramic capacitor and the multi-layered ceramic varistor are formed at one side and the other side end portions of an assembly in which the multi-layered ceramic capacitor and the multi-layered ceramic varistor are assembled, and after the first and second electrodes are formed, a parylene or silicon coating is performed in a vacuum impregnation method on the outer surface of the assembly; and
a step of forming first and second electrodes by performing a barrel polishing process before forming first and second plating layers on outer surfaces of the first and second electrodes, respectively, after performing the insulation and moisture-resistant coating impregnation step.

14. The manufacturing method of claim 11, wherein the first and second electrodes are partially formed on only a partial area of both sides required for electrical connection with the first to fourth internal electrodes, and widths (A1) of the first and second electrodes are set to be in a range where 0.8×A2<A1<1.2×A2, and thicknesses of the first and second electrodes are set to 0.1 μm to 5 μm, respectively.

15. The manufacturing method of claim 10, wherein the burning out and sintering of the plurality of MLCC green chips and the plurality of MLV green chips comprises burning out the plurality of MLCC green chips and the plurality of MLV green chips at a temperature of about 200° C. to about 250° C. for about 40 hours to about 80 hours, and then sintering the plurality of MLCC green chips and the plurality of MLV green chips at a temperature of about 1200° C. to about 1260° C. under a reduction atmosphere.
